(19) United States
(12) Patent Application Publication
(10) Pub. No.: US 2017/0254643 A1
(43) Pub. Date: Sep. 7, 2017

(54) LAWN MOWER BLADE LEVELING DEVICE

(71) Applicant: Jonathan Telliard, Oak Harbor, OH (US)

(72) Inventor: Jonathan Telliard, Oak Harbor, OH (US)

(21) Appl. No.: 15/288,889

(22) Filed: Oct. 7, 2016

Related U.S. Application Data
(60) Provisional application No. 62/303,482, filed on Mar. 4, 2016.

(51) Int. Cl. G01C 9/28; G01C 9/06; A01D 34/82

(52) U.S. Cl. CPC G01C 9/28; A01D 34/82; G01C 9/06; G01C 2009/066

(57) ABSTRACT

A blade balancing device comprises a base member including an upwardly extending pin and a hollow cone configured to rest on the pin of the base member. The hollow cone includes a leveling element disposed at an apex thereof. The leveling element is configured to provide visual indication of a tilt of a lawnmower blade disposed on the hollow cone relative to a gravity direction.

### CROSS-REFERENCE TO RELATED APPLICATION(S)

The present application claims priority to U.S. Provisional Patent Application No. 62/303,482 filed on Mar. 4, 2016, entitled “LAWN MOWER BLADE LEVELLING DEVICE” the entire disclosure of which is incorporated by reference herein.

### BACKGROUND OF THE INVENTION

1. Field of Invention

The present invention relates to the field of lawn mower blade leveling devices, and more specifically to a lawn mower blade leveling device including a bubble level feature.

2. Description of Related Art

It is common for a blade of a lawn mower to periodically be sharpened in response to the blade becoming dulled or otherwise damaged following operational use thereof. It is important that the blade be sharpened in a manner that maintains an equal weight distribution relative to a central rotational axis thereof in order to appropriately balance the blade when installed to the associated mower. An imbalance of the blade is preferably avoided as such an imbalance can lead to an increased wear on rotational components of the mower and an increased degree of vibration present within the mower each of which contributes to shortening an effective life of the lawn mower. Aside from the lawnmower, an imbalance in the blade can result in increased stress and user fatigue as well as create potentially dangerous situations.

Blade balancing devices of the prior art typically include a cone-shaped blade balancer disposed on a pin extending upward from a base member. The blade balancer typically includes at least one circular ledge formed thereon for supporting and locating a central mounting hole of the blade. The blade balancer further includes a cone-shaped hollow interior defined by an inner wall that is inwardly tapered to a pointed end. A pointed end of the pin extends into a hollow interir of the blade balancer and engages the pointed end of the hollow interior. The interface of the pointed end of the pin and the pointed end of the hollow interior of the blade balancer accordingly allows the blade balancer to tilt in any direction relative to the pointed end of the pin. As such, when a blade is placed on the blade balancer a weight distribution of the blade can be determined by comparing the tilt of the blade balancer relative to the stationary base member from which the pointed pin extends. Such a blade balancing device is disclosed by U.S. Pat. No. 2,803,964 to Smith, which is hereby incorporated herein by reference in its entirety.

This method of relying solely on a visual relationship between the blade balancer and the base member presents several concerns. In some instances it is impossible to determine if the blade balancer is tilted relative to the base member due to the base member itself being tilted with respect to a gravity direction. For example, if the base member is disposed on a non-level surface it is possible that the user of the device will improperly determine that the blade is balanced by referring only to the relationship between the blade balancer and the base member. In other instances, many users of such a blade balancing device exclusively reference a visual tilt of the lawn mower blade resting on the blade balancer relative to background features present within a view of the user, such as adjacent table tops, wall edges, and the like. If such features are not arranged perpendicular to the gravity direction the user can improperly determine that the blade is balanced by improperly comparing a tilt of the blade relative to a non-level background feature. Additionally, defects present within the base member or the blade balancer may further alter a visual appearance of the tilt of the blade balancer relative to the base member.

It would therefore be desirable to produce a blade balancing device providing a secondary method of determining if a blade is balanced thereon with respect to the gravity direction.

Based on the foregoing, there is a need in the art for a blade balancer that will allow for the precise weight distribution measurement necessary to properly maintain blades. Such precise measurement requires a device and system having an omnidirectional balance capabilities as opposed to the current state of the art allowing only for a linear balancing without any precise measurement capability.

### SUMMARY OF THE INVENTION

Compatible and attuned with the present invention, a device for determining a tilt of a lawn mower blade relative to a gravity direction has surprisingly been discovered.

In an embodiment, a blade balancing system comprises a base member having a pin extending upward from a central axis of the base member; a hollow cone having an interior apex and an exterior apex, wherein the pin pivotally engages the interior apex of the hollow cone, and wherein the hollow cone engages one or more apertures of a blade; and a leveling element in communication with the exterior apex, wherein the leveling element comprises a visual indicator, wherein the visual indicator provides indication of a tilt of the blade relative to a gravity direction when the blade is engaged with the hollow cone, and wherein a user modifies the blade based on the indication from the leveling element.

In an embodiment, the leveling element is cylindrical, and wherein the visual indicator comprises a fluid chamber having a gas bubble disposed therein.

In an embodiment, the visual indicator is a light or color indicator.

In an embodiment, the user modifies the blade through a method comprising the steps of: the user placing the base member on a surface, wherein the base member is placed on a surface with the pin extending upward relative to the base and the surface; the user placing the hollow cone onto the pin, wherein the pin matingly engages an interior of the hollow cone; zeroing out the hollow cone, wherein the user allows the hollow cone to rest on the pin, wherein the hollow cone is at zero when the visual indicator is coaxially aligned with the pin; the user placing a blade over the exterior apex of the hollow cone, wherein the blade comprises an aperture at a midsection of the blade; the user inspecting the visual indicator, wherein the visual indicator is either axially aligned with the pin and interior apex or the visual indicator is not coaxially aligned with the pin and the interior apex, and if the visual indicator is not coaxially aligned, the method further comprises the steps of: the user removing material from a side of the blade identified as out of balance. Then the user re-inspects the visual indicator, wherein if the visual indicator is at zero, the user replaces the blade onto a lawnmower.

In an embodiment of the invention, a blade balancing device comprises a base member including an upwardly extending pin and a hollow cone configured to rest on the pin of the base member. The hollow cone includes a leveling element disposed at, onto, or within an apex thereof. The leveling element is configured to provide visual indication of a tilt of the hollow cone relative to a gravity direction.

A method of using a blade balancing device is also disclosed. The method comprises the steps of providing a base member including an upwardly extending pin and a hollow cone configured to rest on the pin of the base member, the hollow cone including a leveling element disposed onto, at, or within an apex thereof, the leveling element configured to provide visual indication of a tilt of the hollow cone relative to a gravity direction; and determining a condition of the leveling element to determine if the hollow cone is tilted relative to the gravity direction.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a cross-sectional view of a blade balancing device according to an embodiment of the present invention;

FIG. 2 is a side elevational view of the blade balancing device, according to an embodiment of the present invention;

FIG. 3 is a photograph showing a side elevational view of the blade balancing device, according to an embodiment of the present invention;

FIG. 4 is a top view of the blade balancing device, according to an embodiment of the present invention;

FIG. 5 is a photograph showing a perspective view of the blade balancing device, according to an embodiment of the present invention;

FIG. 6 is a photograph showing a top view of the blade balancing device, according to an embodiment of the present invention; and

FIG. 7 is a side elevational view of a blade balancing device, according to an embodiment of the present invention.

### DETAILED DESCRIPTION OF PREFERRED EMBODIMENTS

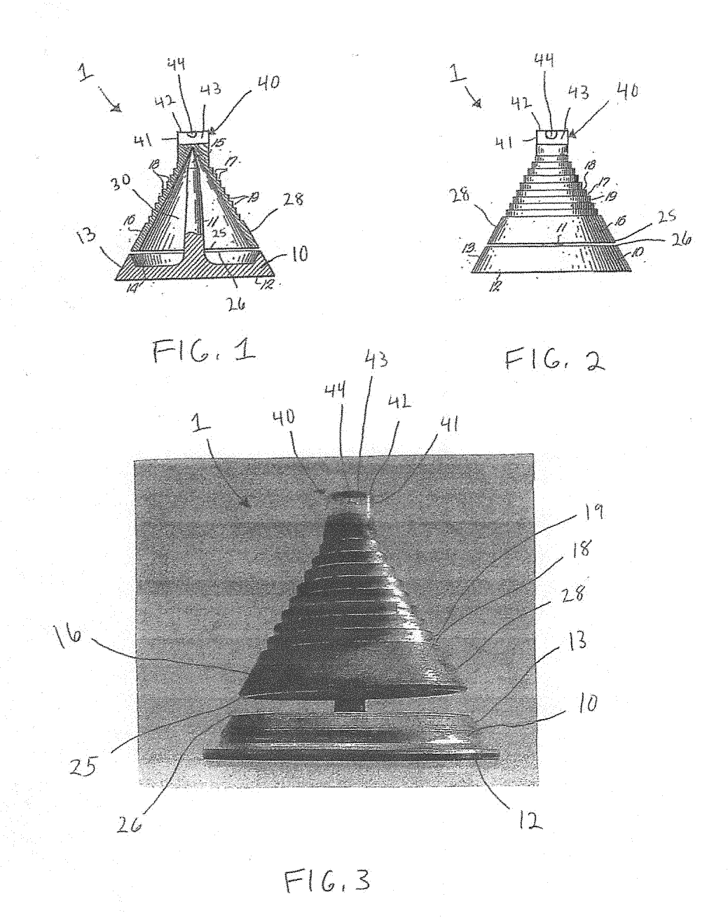

Preferred embodiments of the present invention and their advantages may be understood by referring to FIGS. 1-7, wherein like reference numerals refer to like elements.

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

FIGS. 1-6 illustrate a blade balancing device 1 according to one embodiment of the invention. The blade balancing device 1 comprises a base member 10 and a hollow cone 16. The base member 10 includes a substantially planar lower surface 12 and a tapered outer surface 13. The lower surface 12 is substantially circular in shape and the outer surface 13 has a shape of a frustum. The base member 10 further includes a pin 11 extending upwardly from a central portion thereof. The pin 11 may be further surrounded by an annular hollow opening 14 of the base member 10. The pin 11 extends upwardly until terminating at a pointed tip 15.

The hollow cone 16 includes a substantially cone-shaped outer surface 28 and a substantially cone-shaped hollow interior 30. The outer surface 28 of the hollow cone 16 further includes a plurality of annularly extending circumferential grooves 17 and horizontal shelves 18. The horizontal shelves 18 form a seating surface for supporting a blade of a lawnmower. Each of the circumferential grooves 17 forms a vertical surface 19 corresponding to one of the horizontal shelves 18. Each of the vertical surfaces 19 has an outer diameter selected to correspond to an inner diameter of a central opening of a correspondingly dimensioned blade. In some embodiments, each of the vertical surfaces 19 has an outer diameter corresponding to a central opening of a blade having an inner diameter. The diameter may be measurable through any standard of measurement including but not limited to U.S. standards or the metric system standards. In other embodiments, each of the vertical surfaces 19 has an outer diameter corresponding to a central opening of a blade having an inner diameter measured in standard metric unit dimensions. In a preferred embodiment, a combination of a plurality of vertical surfaces 19 having an outer diameter and a plurality of vertical surfaces 19 having an outer diameter measured in metric unit dimensions is utilized, thereby advantageously allowing a single hollow cone 16 to accommodate lawnmower blades. As such, the alternating pattern of the horizontal shelves 18 and the vertical surfaces 19 allows for a variety of different blades having central openings with differing inner diameters to be suitable for balancing on the blade balancing device 1.

As shown in FIGS. 1-6, a lower most portion 25 of the hollow cone 16 is spaced apart from an uppermost portion 26 of the outer surface 13 of the base member 10 when the hollow cone 16 is supported on the pointed tip 15 of the base member 10. Additionally, the outer surface 13 of the base member 10 is arranged substantially parallel to the outer surface of the hollow cone 16 about a circumference of each of the base member 10 and the hollow cone 16, causing the base member 10 and the hollow cone 16 to cooperate to be substantially cone-shaped in appearance.

The hollow cone 16 includes a leveling element 40 disposed on the outer surface 28 of the hollow cone 16 at an apex thereof. The leveling element 40 is configured to provide a visual indication of a tilt of the hollow cone 16 relative to a gravity direction. The leveling element 40 maybe substantially cylindrical in shape including an outer circumferential surface 41 and a substantially planar upper surface 42. The leveling element 40 includes a substantially cylindrical fluid chamber 43 filled at least partially with a first fluid. A portion of the fluid chamber 43 is devoid of the first fluid to form a gas bubble 44 within the fluid chamber 43.

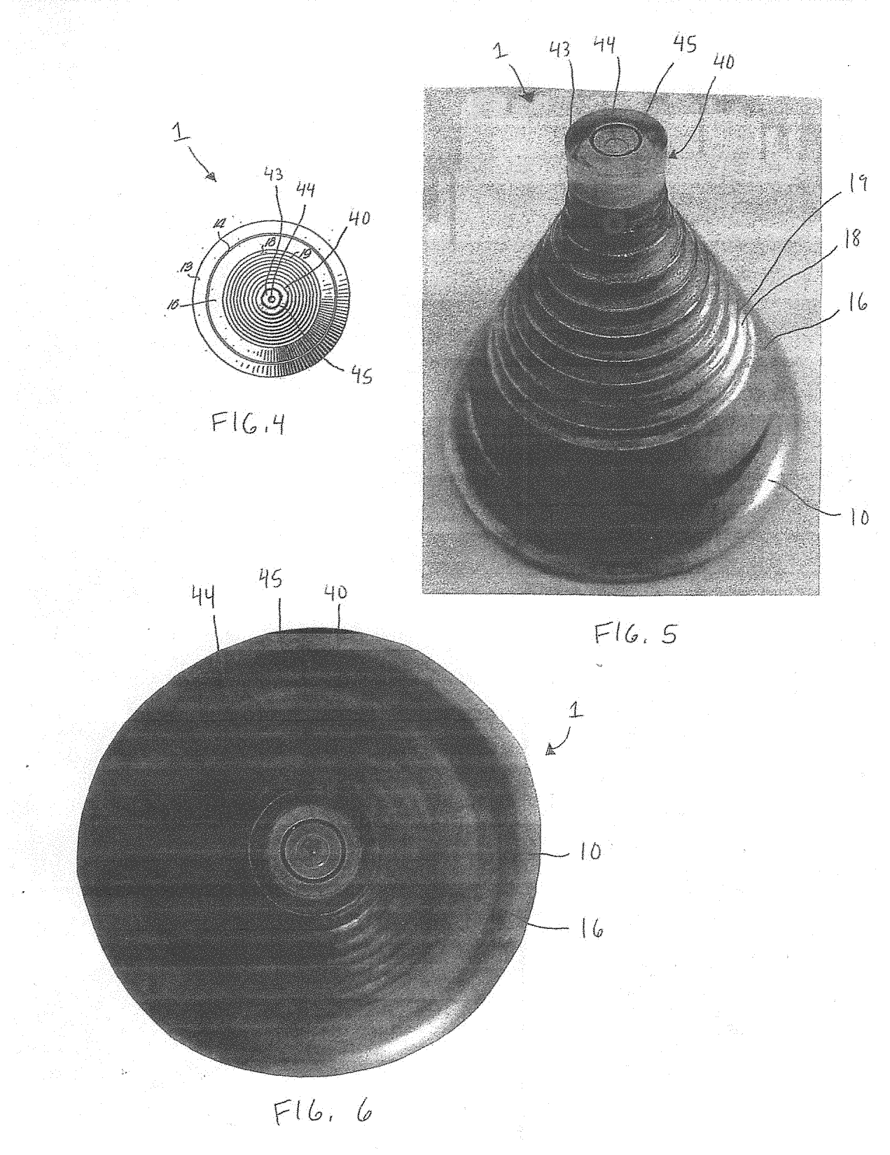

As shown in FIGS. 4-6, the upper surface 42 of the leveling element 40 includes at least one visual indicia 45 formed thereon. The visual indicia 45 may be substantially circular in shape and may be centered on the upper surface 42 of the leveling element 40. At least a portion of the upper surface 42 of the leveling element 40 is transparent to allow a user to visually identify a position of the gas bubble 44 relative to the visual indicia 45 when the gas bubble 44 translates within the fluid chamber 43 of the leveling element 40.

In use, the hollow cone 16 is disposed on the pin 11 of the base member 10, The point contact between the pointed tip 15 of the pin 11 and an inner surface of the hollow cone 16 allows for the hollow cone 16 to attain a balanced state relative to the gravity direction. Once the hollow cone 16 is positioned on the base member 10 the central opening of the blade is then placed over the properly dimensioned vertical surface 19 of the hollow cone 16 to position the blade on a corresponding horizontal shelf 18 of the hollow cone 16. When in this position a variation of a mass of any side of the blade relative to the central opening will result in the blade and therefore hollow cone 16 being tilted relative to the base member 10. The user can then determine if the blade is balanced by checking each of a tilt of the lowermost portion 25 of the hollow cone 16 relative to the uppermost portion 26 of the outer surface 13 of the base member 10, a tilt of the blade itself relative to a horizontally extending reference line present within view of the user, and a position of the gas bubble 44 relative to the visual indicia 45. As explained herein above, mere reference to a tilt of the hollow cone 16 or the blade itself can lead to an improper determination of the tilt of the blade due to several factors. Accordingly, the leveling device 40 prevents such an occurrence of an improper determination of the tilt of the blade by providing an indication of a tilt of the blade relative to the gravity direction that is independent of a visual appearance of the blade relative to the visible surroundings.

As should be understood, a position of the gas bubble 44 relative to the visual indicia 45 will change as a result of a buoyancy force acting on the gas bubble 44 causing the gas bubble to move towards an uppermost position within the fluid chamber 43 relative to the gravity direction. When the upper surface 42 of the leveling element 40 is arranged perpendicular to the gravity direction the gas bubble 44 is caused to move to a central position relative to the visual indicia 45 due to a pressure equalization of the fluid surrounding the gas bubble 44 when in this configuration.

The leveling element 40 accordingly aids the user in confirming that the blade is balanced relative to the gravity direction by allowing the user to determine if the lower surface 12 of the base member 10 is also disposed on a level surface by checking the position of the gas bubble 44. This feature therefore prevents an incidence of an imbalanced blade resulting from the user misidentifying a tilt of the hollow cone 16 relative to the base member 10, the user attempting to balance the blade on a surface that itself is not level, or the user improperly referencing surrounding surfaces relative to the blade that are themselves not level.

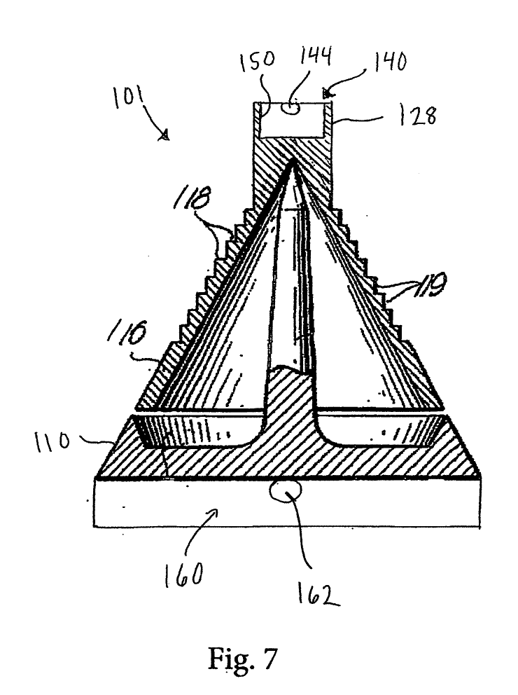

Referring now to FIG. 7, a blade balancing device 101 according to another embodiment of the invention is disclosed. The blade balancing device 101 is substantially similar to the blade balancing device 1 of FIGS. 1-6 and includes a hollow cone 116, a base member 110, a plurality of horizontal shelves 118, a plurality of vertical surfaces 119, and a leveling element 140. The blade balancing device 101 differs from the blade balancing device 1 in that the leveling element 140 is received or molded into a substantially cylindrical opening 150 formed adjacent an apex of the hollow cone 116. Accordingly, a least a portion of an outer surface 128 of the hollow cone 116 annularly surrounds the leveling element 140. This arrangement of the leveling element 140 being disposed or molded within a portion of the hollow cone 116 itself rather than being disposed directly on an uppermost surface of the hollow cone 116 advantageously prevents an incidence of the leveling element 140 being damaged or displaced from the remainder of the hollow cone 116. Furthermore, the outer surface 128 of the hollow cone 116 may be formed to be substantially opaque to encourage a user of the leveling element 140 to determine a position of a gas bubble 144 formed therein from a substantially vertical direction, thereby ensuring that assumptions regarding a position of the gas bubble 144 from a non-perpendicular direction are avoided.

The blade balancing device 101 illustrated in FIG. 7 further includes a base leveling element 160. The base leveling element 160 is configured to provide a user of the blade balancing device 101 a visual indication of a tilt of the base member 110 relative to the gravity direction. The base leveling element 160 may be substantially cylindrical in shape and may include a single gas bubble 162 configured to indicate a tilt of the base leveling element 160. This added form of leveling device aids the user in confirming that the surface on which the base member 110 is disposed is itself level, thereby preventing an incidence of an improperly determined tilt of a blade.

In an alternative embodiment, the blade balancing device has a base where a pin extends upward from a central axis of the base. The leveling element separate frustaconical shaped structure wherein the exterior surface is smooth, textured, or stepped to allow for proper seating of a blade placed thereon. The distal point of the pin engages an interior apex of the frusticonical structure wherein the apex is coaxially aligned with the pin and the central axis of the base. The exterior apex of the frusticonical leveling element is opposite of the interior apex. The leveling element with the gas bubble is affixed to the exterior apex. The attachment between the gas bubble leveling device and the exterior apex is either permanent wherein the leveling element is integrated into the exterior apex, or within the exterior apex. The leveling element may also be removeable attached whereby the leveling element and the exterior apex comprise corresponding magnets for attraction, a friction attachment, or a hook and loop attachment. In yet another embodiment, the leveling element operates without a gas bubble where the leveling element has a visual indicator such as a color or a light to indicate a true level relative to the weight distribution of the blade.

From the foregoing description, one ordinarily skilled in the art can easily ascertain the essential characteristics of this invention and, without departing from the spirit and scope thereof, can make various changes and modifications to the invention to adapt it to various usages and conditions.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A blade balancing system comprising:
a. a base member having a pin extending upward from a central axis of the base member;
b. a hollow cone having an interior apex and an exterior apex, wherein the pin pivotally engages the interior apex of the hollow cone, and wherein the hollow cone engages one or more apertures of a blade; and
c. a leveling element in communication with the exterior apex, wherein the leveling element comprises a visual indicator, wherein the visual indicator provides indication of a tilt of the blade relative to a gravity direction when the blade is engaged with the hollow cone, and wherein a user modifies the blade based on the indication from the leveling element.

2. The system of claim 1, wherein the leveling element is cylindrical, and wherein the visual indicator comprises a fluid chamber having a gas bubble disposed therein.

3. The system of claim 5, wherein the visual indicator is a light or color indicator.

4. The system of claim 2, wherein the user modifies the blade using a method comprising the steps of:
a. the user placing the base member on a surface, wherein the base member is placed on a surface with the pin extending upward relative to the base and the surface;
b. the user placing the hollow cone onto the pin, wherein the pin matingly engages an interior of the hollow cone;
c. zeroing out the hollow cone, wherein the user allows the hollow cone to rest on the pin, wherein the hollow cone is at zero when the visual indicator is coaxially aligned with the pin;
d. the user placing a blade over the exterior apex of the hollow cone, wherein the blade comprises an aperture at a midsection of the blade;
e. the user inspecting the visual indicator, wherein the visual indicator is either axially aligned with the pin and interior apex or the visual indicator is not coaxially aligned with the pin and the interior apex
f. if the visual indicator is not coaxially aligned, the method further comprises the steps of:
i. the user removing material from a side of the blade identified as out of balance;
g. the user re-inspecting the visual indicator, wherein if the visual indicator is at zero, the user replaces the blade onto a lawnmower.
